(19) United States
(12) Patent Application Publication
(10) Pub. No.: US 2020/0031234 A1
(43) Pub. Date: Jan. 30, 2020

(54) SELF-CHARGING ELECTRIC CAR SYSTEM

(71) Applicant: Regnault Umaru Bamiji, Abuja (NG)

(72) Inventor: Regnault Umaru Bamiji, Abuja (NG)

(21) Appl. No.: 16/046,058

(22) Filed: Jul. 26, 2018

(51) Int. Cl. B60L 11/18; H02J 7/04; H01M 10/0525

(52) U.S. Cl. CPC B60L 11/185; H02J 2007/0037; H01M 10/0525; H02J 7/045

(57) ABSTRACT

A self-charging electric car system, includes a input batteries 1, Dual polar motor magnet generator 4, Ultra capacitor modules 5, which forms a charging unit producing charging current for charging the electric car lithium batteries 7 via the batteries isolator 6, thereby keeping the lithium batteries charged all the time to power the gear motor, without the need for charging station.

This invention relates to self-charging electric car system. The current models of electric cars are limited to charging stations and depletion of batteries when driving, where the depleted batteries needs to be charged before driving the electric car, and this could cause unnecessary delays both to the drivers and passengers due to stop time to charge the batteries, aside the availability of this charging stations is one of the biggest problem that needs to be overcome. In most cases batteries may deplete in a place where there is no charging stations. Worst of all, in African countries where such charging stations are not readily available it makes the electric cars technology uninteresting and absolutely impossible to drive electric cars in those regions. While in countries where this charging stations are available, charging of the electric car batteries are not free, bills are paid for every charge making it almost similar to buying gas at filling stations. All this disadvantages causes discomfort to the driver and passengers, making the electric car undesirable, cumbersome and uninteresting, at the end of it all the charging stations becomes a necessary inconvenience.

To overcome this, the present invention proposes a self-charging system in the electric car that keeps the battery system charged at all time and extending drive time. This is made possible by installing a dual polar magnet motor generator in the electric car power system. The Dual Polar magnet power generator uses batteries at its input and output, but in this case the output batteries are replaced with ultra-capacitors modules to provide a fast charge and discharge operation and to store voltage in the ultra-capacitor modules. The dual motor magnet motor generator is a unique and carefully designed pulse motor generator that generates charging current, it is an attraction and repulsion motor, the motor has a very strong pull of permanent magnets through the cores of the coils, while continuing to pulse them away after a top dead center to allow the motor to still run only in repulsion mode, and would mean the motor would be turned ON to attract the magnets in, but that would be worse and is unnecessary with this motor as they do it on their own without the need to turn ON the motor at that point. Hence the motor still runs the same way, increasing the torque because the natural attraction adds to the motor, causing it to spin at a very high speed, producing charging current through it coils to charge the Ultra capacitors modules, the reason why ultra-capacitors modules are used at the output of the Dual polar magnet motor generator instead of its original batteries is to create a fast charge, making the ultra-capacitor module a voltage storage device, that will instantly discharge its voltage to the Electric car lithium batteries, when needed.

The charging system is designed in such a way that the dual polar magnet motor generator needs only a very small fraction of the input batteries voltage to spin at a very high speed to produce the charging current, which fast charges the Ultra capacitor modules and store. When there is a drop in the voltage of the electric car lithium batteries, the batteries Isolator automatically trigger a released from the charged voltage stored in the ultra-capacitor module to the electric car lithium batteries charging it instantaneously, prolonging drive time. The input batteries may occasionally be charged at home, at the driver's convenience.

Since the dual Polar magnet power motor generator takes very small fraction of voltage from the input batteries voltage, the input batteries usually works several hours without the input batteries voltage depleting, due to the operation of the Dual Polar Magnet motor generator. The input battery, the dual polar magnet motor generator and the ultra-capacitor modules forms a complete unit of the charging device, therefore the three components working together in symbiotic fashion to support each other, thereby maintaining an almost full batteries voltage of the input batteries, making the charging unit acts as a mobile charging station for the electric car.

The invention will now be described sorely by way of example and with reference to the accompanying drawings in which:

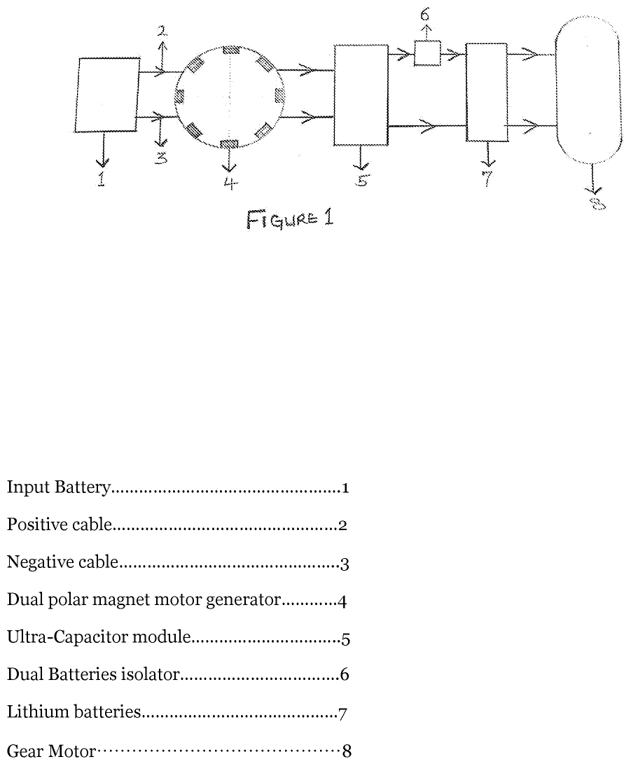

FIG. 1 show the dual polar magnet motor generator 4 connected to input batteries 1, via the positive cable 1 and the negative cable 2, and the output ultra-capacitor module 5 forming the complete unit of battery charging device. The dual polar magnet motor generator 4, is a very unique device, it is a carefully designed pulse motor generator that charges the ultra-capacitor module 5, keeping it charged at all times, while the input batteries 1 supply voltage to the dual polar magnet motor generator 4 causing it to spin at high speed to produce the charging current necessary to keep the ultra-capacitor module 5 charged all the time, yet the input batteries 1 only gives out very small fraction of its voltages to the Dual Polar magnet motor generator 4, and as such the input batteries operates several hours, without depleting in voltage due to symbiotic cooperation of the Dual Polar magnet motor generator 4, the input battery 1 and the ultra-capacitor module 5 that forms the battery charging unit.

When there is a depletion in voltage of the lithium battery 7, that supplies the electric car gear motor 8, the batteries isolator 6, trigger a release and allow discharge of the stored voltage from the charged ultra-capacitor modules 5 to the lithium Batteries 7, giving it a full charge Instantly, Yet the batteries isolator 6, does not allow a flow of voltage from the lithium batteries 7 back to the Ultra capacitor modules 5, making it a unique device. Immediately the Ultra capacitor modules 5, have discharged its voltage to the lithium battery 7, the Ultra capacitor module 5, begins to receive and store charging voltage from the Dual polar magnet motor generator 4 again, this process continues in a vicious cycles to ensures that the electric car's lithium batteries 7, that supply voltage to the gear motor 8, is always charged keeping the car running without the desperate need for a charging station to charge the lithium batteries 7.

1. Self-charging electric car system that comprises of input batteries, dual polar magnet motor generator and ultra-capacitor modules that generates charging current.

2. Self-charging electric car system, according to claim 1, that uses the charging current generated to provide intermittent charging voltage to the electric car lithium batteries thereby providing continuous power the gear motor.

3. Self-charging electric car system, according to claim 1, which provides controlled charging current via the batteries isolator to the lithium batteries ensuring that the electric car's lithium batteries are not overcharged or back-charged to the ultra-capacitor modules.
